(19) United States
(12) Patent Application Publication
(10) Pub. No.: US 2024/0284881 A1
(43) Pub. Date: Aug. 29, 2024

(54) DEPLOYMENT FRAME FOR COMBINING MULTIPLE ARTIFICIAL REEFS

(71) Applicant: QATAR UNIVERSITY, Doha (QA)

(72) Inventors: Bruno Welter GIRALDES, Doha (QA); Eduardo MELLO, East-Perth (AU)

(21) Appl. No.: 18/587,538

(22) Filed: Feb. 26, 2024

Related U.S. Application Data
(60) Provisional application No. 63/447,922, filed on Feb. 24, 2023.

(51) Int. Cl. A01K 61/73; A01K 61/78

(52) U.S. Cl. CPC A01K 61/73; A01K 61/78

(57) ABSTRACT

Certain embodiments are directed to a reef frame, which may include a frame structure including a plurality of interconnected beams. The reef frame may also include a plurality of deployment hooks connected to the frame structure, and configured to connect to a plurality of articles. The reef frame may further include a plurality of buoys attached to each of the plurality of deployment hooks. According to certain embodiments, each of the plurality of deployment hooks is configured to attach to a respective link of each of the plurality of articles.

### CROSS-REFERENCE TO RELATED APPLICATIONS

This application claims priority from U.S. provisional patent application No. 63/447,922 filed on Feb. 24, 2023. The contents of this earlier filed application are hereby incorporated by reference in their entirety.

### FIELD

Some example embodiments may generally relate to artificial reefs. More specifically, certain example embodiments may relate to a deployment frame or framework for combining two or more artificial reef structures for marine or aquatic deployments.

### BACKGROUND

Coral reefs house one of the most significant ocean biodiversities and are considered one of the most important natural assets on earth. Due to anthropogenic pressures and climate change, the biological and economic functionality of this essential ecosystem has decreased in recent decades. Although efforts have been made to reduce the depletion of this natural resource, more coral reef settings are affected annually by bleaching events, or overuse by commercial and industrial sectors, with urban development being one of the most deleterious human threats.

Numerous artificial reef technologies have been designed in recent decades to restore fish stocks and some have been proposed as substrates for coral growth. Only a few technologies, however, have been validated for use at offshore sites, especially regarding stability when facing water currents and the chance of being buried by the sediment carried by these currents. Additionally, most artificial coral reefs are deployed separately, in singular unities and are hardly placed close to each other in a controlled positioning, even with use of divers. Additionally, it is often necessary to deploy a vessel with a spatial positioning system for placing the artificial structure in the right location in the subsea construction. With this traditional deployment method, the artificial structures remain isolated and far separated underwater, and are unable to achieve habitat heterogeneity created by grouped natural reef structures forming a single large coral reef system. The routine use of divers extends the time used for installing large numbers of structures, and reduces the depth that these artificial reefs can be installed.

In view of the above, there is a need for a tool or framework that allows for the deployment of multiple artificial reef units in assemblage.

### SUMMARY

Some embodiments may be directed to a reef frame. The reef frame may include a frame structure including a plurality of interconnected beams. The reef frame may also include a plurality of deployment hooks connected to the frame structure, and configured to connect to a plurality of articles. The reef frame may further include a plurality of buoys attached to each of the plurality of deployment hooks. According to certain embodiments, each of the plurality of deployment hooks may be configured to attach to a respective link of each of the plurality of articles.

Other embodiments may be directed to a method of assembling a reef frame. The method may include assembling a frame structure by connecting a plurality of beams together. The method may also include connecting a plurality of deployment hooks to the frame structure. The method may further include connecting a plurality of articles to the reef frame via the plurality of deployment hooks. In addition, the method may include attaching a buoy to each of the plurality of deployment hooks. According to certain embodiments, each of the plurality of deployment hooks is configured to attach to a respective link of each of the plurality of articles.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 illustrates an example of an article, according to certain embodiments.

FIG. 2 illustrates an example artificial reef, according to certain embodiments.

FIG. 3A illustrates an example assemblage of articles, according to certain embodiment.

FIG. 3B illustrates an example assemblage of a combination of different sized articles, according to certain embodiments.

FIG. 4 illustrates an example lateral view of anchor points of an article, according to certain embodiments.

FIG. 5A illustrates an example of various grouping reef deployment frame layouts and reef configurations, according to certain embodiments.

FIG. 5B illustrates an example of a square layout of a reef frame structure, according to certain embodiments.

FIG. 5C illustrates an example of a circular layout of a reef frame structure, according to certain embodiments.

FIG. 5D illustrates an example of an artificial reef deployment, according to certain embodiments.

FIG. 6 illustrates an example reef frame structure, according to certain embodiments.

FIG. 7A illustrates an example frame and reef structure, according to certain embodiments.

FIG. 7B illustrates an enhanced view of a portion of the reef frame structure of FIG. 7A, according to certain example embodiments.

FIG. 8 illustrates a perspective view of the reef frame structure, according to certain embodiments.

FIG. 9A illustrates an example of an artificial reef deployment sequence, according to certain embodiments.

FIG. 9B illustrates an example of another artificial reef deployment sequence, according to certain embodiments.

FIG. 9C illustrates an example of a further artificial reef deployment sequence, according to certain embodiments.

FIG. 9D illustrates an example of yet another artificial reef deployment sequence, according to certain embodiments.

FIG. 10 illustrates an example flow diagram of a method, according to certain embodiments.

### DETAILED DESCRIPTION

It will be readily understood that the components of certain example embodiments, as generally described and illustrated in the figures herein, may be arranged and designed in a wide variety of different configurations. The following is a detailed description of some embodiments of artificial reefs and an artificial reef deployment frame.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily all refer to the same group of embodiments, and the described features, structures, or characteristics may be combined in any suitable manner in one or more example embodiments.

Additionally, if desired, the different functions or steps discussed below may be performed in a different order and/or concurrently with each other. Furthermore, if desired, one or more of the described functions or steps may be optional or may be combined. As such, the following description should be considered as merely illustrative of the principles and teachings of certain example embodiments, and not in limitation thereof.

As used herein, the phrase “and/or” means a combination or an individual member. As a non-limiting example, “X is A, B, and/or C” encompasses the following possibilities: X is A; X is B; X is C; X is any combination of A, B, and C (A and B; A and C; B and C; A, B, and C). Although already encompassed by the description of singular and plural discussed above, it will explicitly be stated that if A is a genus, “an individual member” and A each encompass one or more members of A. Thus, as applied to the above non-limiting example, “X is A, B, and/or C” encompasses X is one or members of A; X is B; X is C; X is any combination of A, B, and C (B and one or more members of A; C and one or more members of A; B and C; B, C, and one or more members of A). In a likewise manner, “one or members of B” would apply if B were a genus, and the same for C, if C were a genus, etc.

As used herein, words of approximation such as, without limitation, “about,” “substantially,” “essentially,” and “approximately” mean that the word or phrase modified by the term need not be exactly that which is written but may vary from that written description to some extent. The extent to which the description may vary will depend on how great a change can be instituted and have one of ordinary skill in the art recognize the modified version as still having the properties, characteristics and capabilities of the modified word or phrase. In general, but with the preceding discussion in mind, a numerical value herein that is modified by a word of approximation may vary from the stated value by ±10%, unless expressly stated otherwise.

As used herein, any ranges presented are inclusive of the end-points. For example, “a temperature between 10° C. and 30° C.” and “a temperature from 10° C. to 30° C.” include 10° C. and 30° C., as well as any temperature in between.

As used herein, a range may be expressed as from “about” one particular value and/or to “about” another particular value. When such a range is expressed, another embodiment is included, the embodiment being from one particular value and/or to the other particular value. Similarly, when values are expressed as approximations by use of the antecedent “about,” it will be understood that the particular value forms another embodiment. As a non-limiting example, if “from about 1 to about 4” is disclosed, another embodiment is “from 1 to 4,” even if not expressly disclosed. Likewise, if one embodiment disclosed is a temperature of “about 30° C.,” then another embodiment is “30° C.,” even if not expressly disclosed.

As used herein, “at least one of X” or “one or more X” includes the only X if there is only one X, and may include all X, only one X, or an intermediate number of X, to the extent possible, if there are two or more X. As a non-limiting example, if there is only one article, “at least one article” and “one or more articles” would refer to the one article. However, if there are four articles, “at least one article” encompasses one, two, three, or all four articles. Similarly, if there are four articles, “one or more articles” encompasses one, two, three, or all four articles.

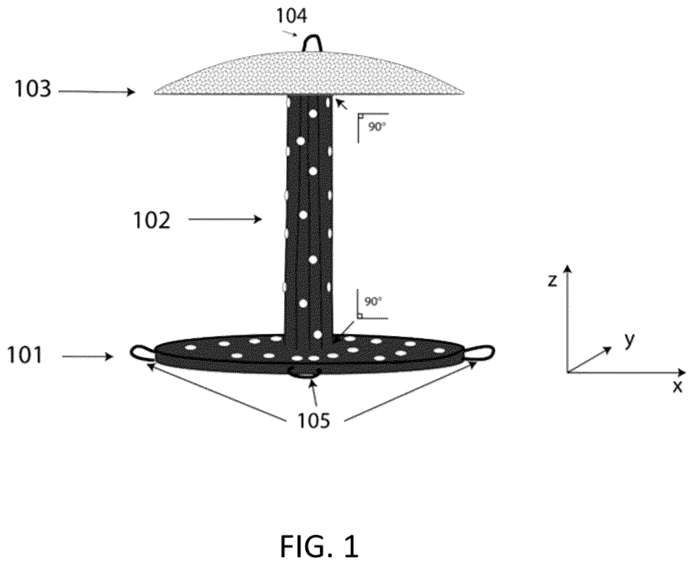

FIG. 1 illustrates an example of an article, according to certain embodiments. The article in FIG. 1, also referred to as a “unit” (e.g., artificial reef), has a base 101, a support column 102 (also referred to as a support member), and a top 103. The overall shape can be described as a “mushroom” attached to a short cylindrically shaped base. Alternatively, the overall shape can be described as a bobbin or spool with one side being a dome or rounded shape (such as, but not limited to, a section of a sphere cut by a plane perpendicular to the axis of the sphere) rather than a disk, or very short cylinder shape. By way of a further non-limiting example, the overall shape can also be described as “Broccoli florets.”

The article in FIG. 1 includes a base 101, with a first surface intended for contact with the sediment at the bottom, that allows for the distribution of the weight over a surface area greater than the average cross-section of the support column, a support column designed to reduce hydrodynamic drag, the support column connected to a second surface of the base at one end of the column, and a top with a substantial surface area to provide habitat for coral and other organisms, the top connected to the other end of the support column. The article in FIG. 1 also includes a link 104 at the top 103 that may be used for deployment (a “deployment link”), which is shown as a U shape. The article shown in FIG. 1 further includes four “anchor points” 105 for attachment to other units.

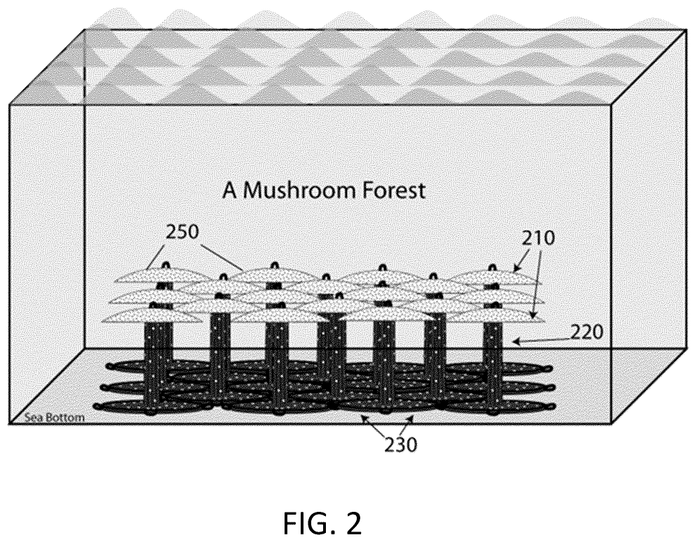

FIG. 2 illustrates an example artificial reef, according to certain embodiments. As illustrated in FIG. 2, the artificial reef may be formed by connecting a number of units 250 of the article illustrated in FIG. 1. The coral reef illustrated in FIG. 2 provides a coral growth habitat 210 that is a large surface area close to incident light that allows for coral growth, a fish habitat 220 that is an area of vertical columns that provides a habitat for some fish species but is not easily moved because the currents can easily flow through the vertical columns, and a large connected base that distributes the weight to limit sinking, that is an interface habitat 230. Certain embodiments may include one or more of these features. The artificial reef of FIG. 2 may be analogous to a forest of trees where each tree has a root system to anchor it, one or more trunks, and a canopy of tree limbs and leaves that shade out most incident light. In some embodiments are articles that may be joined to form an artificial reef that mimics one in nature, and in particular, the natural coral reef shape of Abrolhos, in Brazil (South America), where the corals grow vertically forming columns that spread out laterally as it gets closer to surface, forming a mushroom shape of “calcium-carbonate” material.

In some embodiments, the article may include one or more deployment links 104. In other embodiments, the top 103 of the article may include one or more deployment links 104. In further embodiments, the top 103 may include a first surface and a second surface, the one or more support members 102 being connected to the first surface of the top 103, and the second surface may include, but is not limited to including, the deployment link 104.

In some embodiments, the base 101 is present. The base 101 may be the part of the article intended to be placed on the sediment of the body of water such as the seafloor, and a bottom surface (a first surface) of the base 101 may be intended to be set on the floor. The base 101 may help in distributing the weight of the support 102 and top 103 over a larger surface area than if the support alone were used. In other words, the base 101 may be analogous to snowshoes in function. The base 101 may include a first surface and a second surface. As illustrated in FIG. 1, the base 101 is a very short cylinder with the height being much smaller than the diameter. However, the base 101 is not so limited and the base 101 may be of any shape and/or size. In some embodiments, the base is of the shape of a square, a rectangle, a circle, an oval, or a polygon.

In some embodiments, the base 101 may be irregularly shaped. In other embodiments, the base 101 may include, but is not limited to including, two surfaces that are parallel with each other or approximately parallel with each other (within 20° of parallel). In some embodiments, the base 101 may include, but is not limited to including, two surfaces that are parallel with each other or within 10° of parallel with each other. In further embodiments, the base 101 may be a truncated cone and/or pyramid with a small angle compared to the floor (about 25° or lower, and in some embodiments, about 15° or lower). In other embodiments, the base 101 may be or may include, but is not limited to including, a plate or disk shaped object including, but not limited to including, two surfaces that are parallel with each other or approximately parallel with each other (within 10° of parallel) and are higher surface area than the remaining surfaces, and/or the base is or includes, but is not limited to including, a truncated pyramid or cone with a shallow angle (3 to 15°) with the bottom of the pyramid or cone a plane (the bottom being the surface resting on the floor). In some embodiments, the height of the base 101 may be in the range of 0.07 to 0.15 meters, and the length of a side, of the diameter, and/or the equivalent diameter, that is the diameter of a circle of the same surface area, may be in the range of 0.5 to 3 meters.

Certain embodiments may encompass articles including, but not limited to including, one or more support members 102, wherein each support member 102 may be connected to the top 103 at one end of the support member 102 and the other end of the support member 102 may be connected to the base 101, if present, or may not be connected to the base 101. In some embodiments, a support member 102 not connected to the base 101 contacts the floor when the article is used as intended. The support member 102, or support members, optionally in combination with the base 101 if present, support or at least partially support the top 103 and provides some separation of the top 103 from the sediment at the bottom of the body of water, such as, but not limited to, the sea bed.

A member attached to the top 103 that does not also attach to the base 101 or does not rest on the floor in any configuration in which the article is used as intended, is not a support member. In some embodiments, the support member 102, or support members, optionally in combination with the base 101, if present, support the top 103 at a position in the body of water to allow the top to receive incident light. In some embodiments, the position of the top 103 allows the top 103 to receive sufficient incident light to support coral growth. In some embodiments, the support member 102 may be designed to limit hydrodynamic drag from flowing water when the article is placed under water. In some embodiments, the water flows in a direction parallel and/or approximately parallel (within ±25°) with the base, if present, and/or the top 103. In some embodiments, the water flows in a direction parallel and/or approximately parallel (within ±25°) with the floor. As shown in the exemplary, but not limiting, embodiment of FIG. 1, the support member 102 is a column, but it is not a perfectly cylindrically shaped column. In some embodiments, the support member 102 is a generally elongate member. However, embodiments are not limited to such support members 102.

The shape of the cross-section of the support member 102 is not limited. The cross-section of the support member 102 may be a circle, a triangle, a square, a rectangle, or a polygon of any number of sides (equal to or greater than three, obviously). The cross-section may be of the shape of two or more curves that meet at two or more points on the circumference (a “half-moon” as a non-limiting example). The support member 102 may be L-shaped or U-shaped in cross-section. The cross-section of the support member 102 may be irregularly shaped or of a free-form shape. The cross-section of the support member 102 may be a uniform size from the base to the top or it may be non-uniform. The cross-section shape of the support member 102 may change over the height of the support member 102. The support member 102 may have one or more protrusions or arms. As used herein, a “protrusion” or “arm” differs from undulations or variations in cross-section over the support member height. In some embodiments, a protrusion or arm of the support member 102 is of a length of at least 10% of the equivalent diameter of the cross-section of the support member at the point where the protrusion or arm is attached to the support member, but not including the protrusion or arm in the cross-sectional area. In some embodiments, an arm extends from one support member and connects to another support member. In other embodiments, the support member 102 may be free of protrusions or arms. In further embodiments, protrusions or arms are present, and at least 70% of the height of the support member is free of bar arms or protrusions. In some embodiments, the support is a tube.

In some embodiments, the support member 102 is an elongate member including a bore hole extended from the bottom (connection to the base if present) to the connection with the top 103. In certain embodiments, the shape of the cross-section may be the same over the height of the support member 102. In some embodiments, the shape of the cross-section is the same over at least over at least 85% of the height of the support member 102. In other embodiments, the support member 102 may be tapered with a larger cross-sectional area at the end that connects with the base (if present) and a smaller cross-sectional area at the end that connects with the top. In some embodiments, the support member 102 may be tapered and the ratio of the cross-sectional area of the end connecting with the top 103 to the other end being in the range of about 0.15 to about 0.95. In some embodiments, the support member 102 may be tapered and the ratio of the cross-sectional area of the end connecting with the top 103 to the other end being in the range of about 0.10 to about 0.75. In some embodiments, the support member 102 may be tapered and the ratio of the cross-sectional area of the end connecting with the top 103 to the other end being in the range of about 0.70 to about 0.90. If there are multiple support members 102, the support members 102 may not all be the same. The support members 102 may differ shape and/or size.

As illustrated in the embodiment of FIG. 1, the top 103 is a circular dome-shaped object with a height that is smaller than the diameter. However, the top 103 is not so limited, and the top 103 may be of any shape and/or size. In some embodiments, the top 103 may be a shape of a square, a rectangle, a circle, an oval, or a polygon. In other embodiments, the top 103 is irregularly shaped. In further embodiments, the top 103 may be a free form shape. In some embodiments, the top 103 may be a hemisphere or section of a sphere in shape (where a section of a sphere is the portion of a sphere cut by a plane perpendicular to the axis of the sphere, and a hemisphere is a section where the plane intersects the center of the sphere). In some embodiments, the top 103 may be a curved shape or domed shape that is not a true hemisphere, and is not a true section of a sphere in shape. In some embodiments, the top 103 may be a pyramid or a truncated pyramid, where the base of the pyramid may be any shape, including, but not limited to, a rectangle, a circle, an oval, a square, or a polygon. A truncated pyramid may be truncated by a plane dissecting the pyramid that is parallel to the base (preferred embodiments) or a plane that is not parallel to the base. In other embodiments, the top 103 may be a dome shaped article like an umbrella that is part of a hollow sphere. In further embodiments, the top 103 may be two or more pieces and each piece is connected to a support member 102 and/or another top piece.

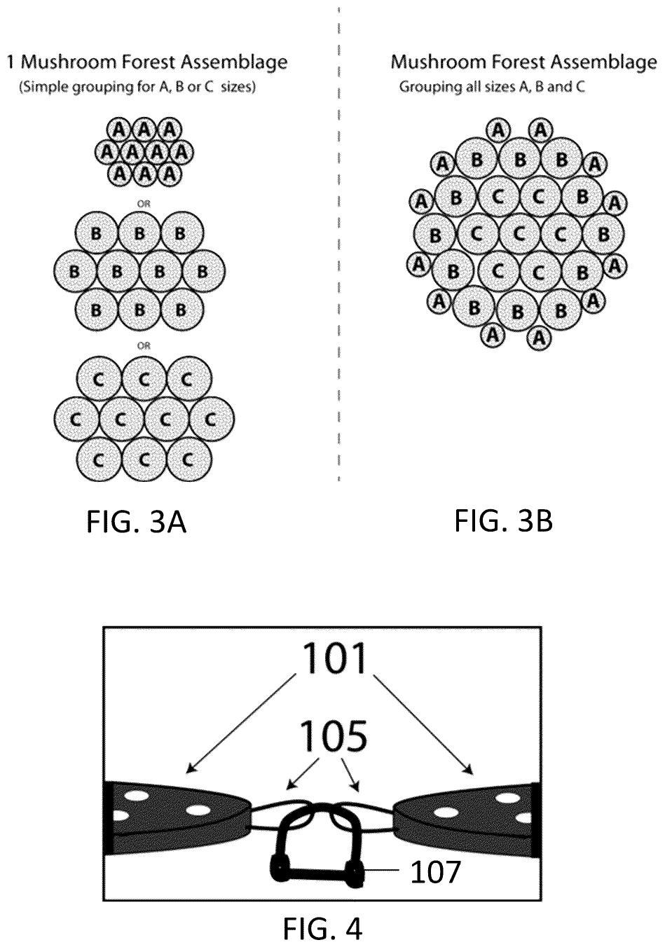

FIG. 3A illustrates an example assemblage of articles, according to certain embodiment, and FIG. 3B illustrates an example assemblage of a combination of different sized articles, according to certain embodiments. As shown in FIG. 3A, the artificial reef may be an assemblage of articles (or units) of a single article size, or as shown in FIG. 3B, the artificial reef may be an assemblage of articles (or units) combining different sizes in an assemblage.

FIG. 4 illustrates an example lateral view of anchor points of an article, according to certain embodiments. In some embodiments, the base 101 may include, but is not limited to including, anchor points 105. An anchor point allows the article (unit) to be connected to one or more other articles (units) to form at least a part of an artificial reef. In some embodiments, a unit may include a base 101 including multiple pieces and all pieces of the base may include, but are not limited to including, one or more through anchor points 105. In some embodiments, a unit may include a base 101 including multiple pieces and at least one of the pieces of the base includes, but is not limited to including, one or more anchor points 105. In certain embodiments, the base 101 may include one or more anchor points 105. The exemplary non-limiting embodiment shown in FIG. 1 includes four (4) anchor points 105 distributed approximately equally around the circular base/cylindrical shaped base, that is about 90 degrees apart. The anchor points depicted in the exemplary, but non-limiting, embodiment shown in FIG. 1 are U shaped protrusions from the side of the base 101. In some embodiments, the anchor points 105 on at least one base member 101 (and in some embodiments, if multiple base members are present, all base members) of the unit are protrusions 105 from the base 101 allowing for connection to the base of at least one other unit. In some embodiments, the anchor points 105 are made of one or more materials where at least one of the one or more materials is a metal. In some embodiments, the protrusions 105 are in the shape of a U. In some embodiments, the protrusions 105 are in the shape of an “eye” (loop) like that of a hook and eye connector. The protrusions 105 allow for a chain, rope, and/or a link 107 of a chain, to be hooked through the U or loop shaped protrusions to connect the units. An example is shown in FIG. 3. In some embodiments, an anchor point is a large through hole near the edge of the base that allows for a chain, rope, and/or a link of a chain, to be hooked through the through hole and connected to another unit. A combination of different types of anchor points may be used. Different pieces of the base may include different types of anchor points 105, and/or multiple different types of anchor points 105 may be used on the base 101 (or at least one piece of the base if the base is multiple pieces.

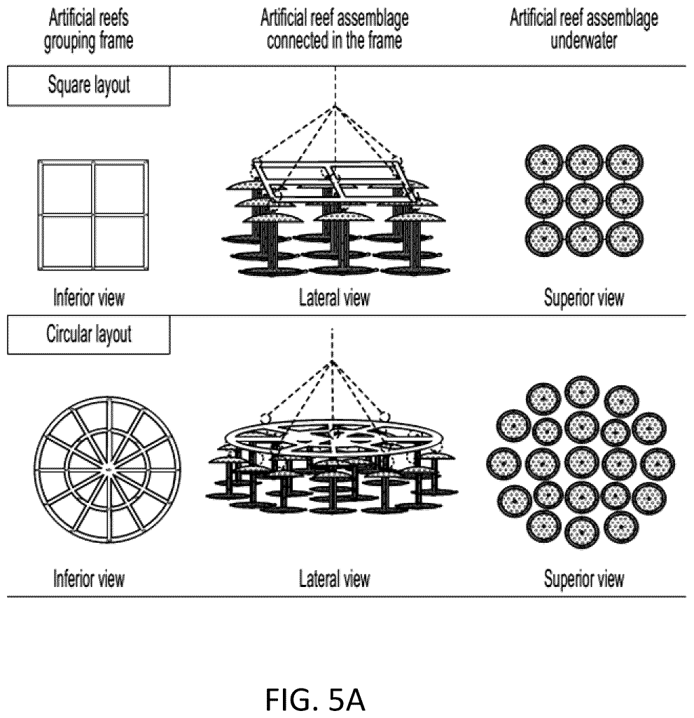

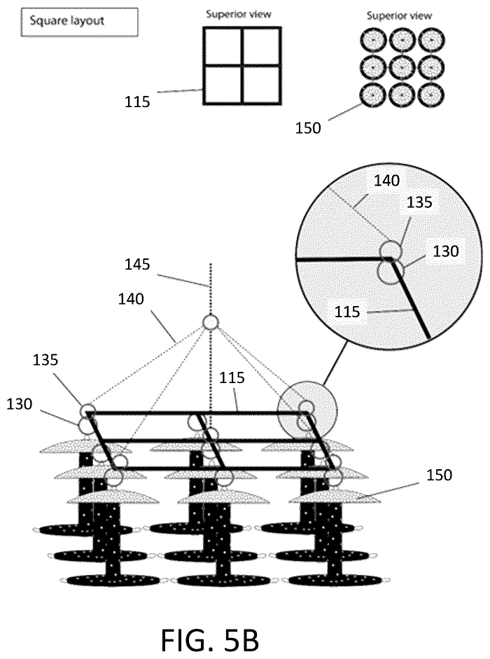

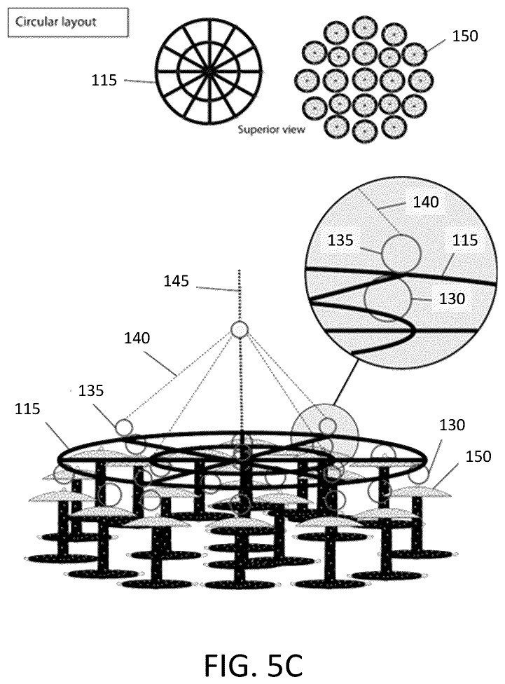

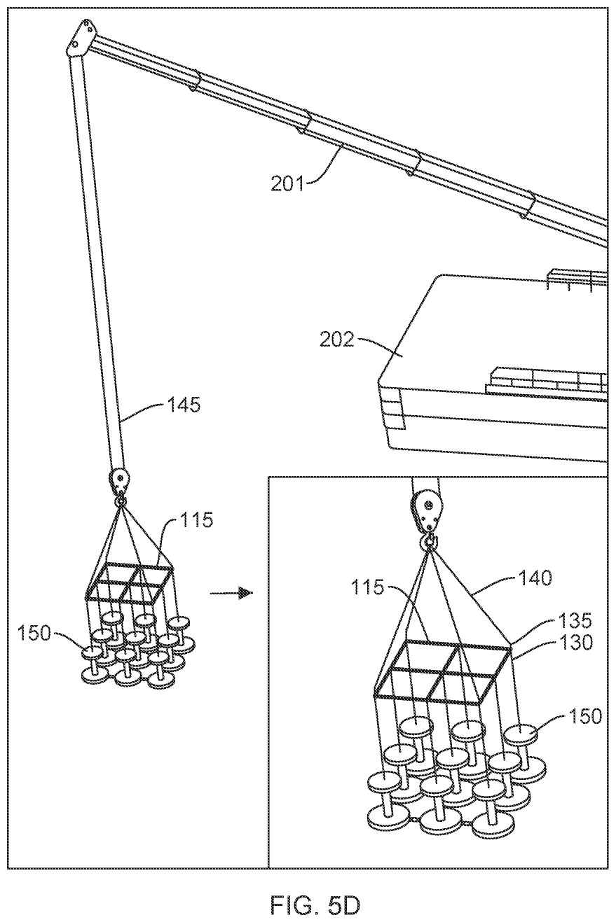

FIG. 5A illustrates an example of various grouping reef deployment frame layouts and reef configurations, according to certain embodiments. As illustrated in FIG. 5, the frame may be structured in, but not limited to, various shapes such as, for example, a square layout and/or a circular layout. The assembled frame may be connected to the artificial reef assemblage, and provide the ability for the entire artificial reef assemblage to be connected to the frame and deployed in the ocean as one single collective structure.

According to certain embodiments the reefs' deployment frame may be applicable for grouping artificial reefs and deploying them together, without assistance of divers, aiming increase the habitat heterogeneity of artificial reef structures. Certain embodiments of the reefs' deployment frame may be configured to function as a tool to be used in subsea construction, more specifically, to be used during the deployment of a pack of artificial reefs. In some embodiments, the frame may used/deployed with cranes on vessels and barges.

As illustrated in FIG. 5, the frame may function as a tool that allows the deployment of artificial reefs in assemblage. Thus, certain embodiments of the grouping reefs' deployment frame may improve the technology of subsea construction for the creation of large artificial reef system, with high habitat heterogeneity, assembling several unities with high proximity in a single spot. Certain embodiments of the grouping reefs' deployment frame may also simulate the habitat heterogeneity created in natural coral reef systems. In other words, the system may allow for the creation of biomimetic patterns of the natural habitat heterogeneity of coral reefs. Furthermore, the use of the self-releasing grouping-frame can provide the ability to install the group of artificial-reefs without assistance of divers.

According to certain embodiments, the size of the grouping reefs' deployment frame and the number and weight of the artificial reef may increase the total weight for the reef assemblage for the deployment, requiring a larger crane proportional to the total weight. The space available in the vessel or barge may be a limitation according with the total size aimed to produce. This limitation may be solved by selecting a crane proportional to the required total weight and by selection a vessel/barge with available species for the desires area used by the reef's assemblage.

FIG. 5B illustrates an example of the square layout of the reef frame structure, according to certain embodiments. FIG. 5C illustrates an example of the circular layout of the reef frame structure, according to certain embodiments. As illustrated in FIGS. 5B and 5C, the frame structure 115 (e.g., deployment frame) may have a square layout design or a circular layout design, and the artificial reefs 150 may be configured as shown in FIGS. 5B and 5C after underwater deployment. In the upper part of FIGS. 5B and 5C, the frame 115 and the expected grouped reefs layout (superior view) may use the square or circular layout design. The lower part of the FIGS. 5B and 5C illustrates the frame 115 and the reefs 150 during the deployment process (detailing the upper link 135 and the lower link 130).

As illustrated in FIGS. 5B and 5C, the deployment frame 115 can have different shapes according to the shape of the aimed subsea construction. The frame 115 may be connected to the artificial reefs 150 (e.g., Mushroom Forest Artificial Reefs) via upper links 135 connected to lower links 130. The upper links 135 (in other embodiments, a connection may be with different types of links) is placed on top of the deployment frame 115. This top links 135 on the deployment frame 115 connects the deployment frame 115 to the cable (e.g., steel wire cables) 105 that lifts the frame 115 and reefs 150. The lower links 130 (in other embodiments, a connection may be made with different types of links) may be placed on the basally of the deployment frame 115. This basal link on the deployment frame 115 connects the deployment frame 115 to the artificial reefs 150. As illustrated in FIGS. 5B and 5C, the artificial reefs 150 may be linked to the frame 115 to from a desired layout according to the deployment frame design. As further illustrated in FIGS. 5B and 5C, cables (e.g., steel wire cables) 140 connects the top links 135 to a cable 145 from a crane. The cable 145 from the crane may be a deployment cable (e.g., thicker steel wire cable) that is connected to the sequence of cables 140 in the basal portion, and to the crane on the top portion.

According to certain embodiments, the frame 115 may be made of steel such as, for example galvanized steel, or other steel composition according to the calculation of the lifted weight. The artificial reefs 150 may be made from different, non-limiting, materials such as, for example, precast (e.g., concrete), stones, or ceramic. The cables/ropes 140 may be steel wire cables/ropes with strong fastened eye loops that can be galvanized stainless or different materials and sizes according to the subsea/ocean engineering strategy. The upper and lower links 135, 130 may be made using lifting eye bolts. The upper and lower links 135, 130 may also be galvanized stainless or different materials and sizes according to the subsea/ocean engineering strategy. In some embodiments, the connection between the upper and lower links 135, 130 with the cables 140 may be made using steel rigging shackles. The steel rigging shackles may be galvanized stainless or different materials and sizes according to the subsea/ocean engineering strategy. In some embodiments, the connection between the steel rigging shackles on the lower links 130 and the artificial reefs 150 may depend on the easy release methods selected by the subsea/ocean engineering.

As illustrated in FIGS. 5B and 5C, the frame 115 and artificial reefs 150 may be assembled to form the overall structure. For instance the deployment frame parts may be welded (based on engineering calculation of the required resistance), and the parts of the overall structure of the deployment frame 115 may also be connected by screws (based on the engineering calculation of the required resistance). The upper and lower links 135, 130 may be welded on the deployment frame 115, and the upper and lower links 135, 130 may be made using lifting eye bolts. The lifting eye bolts with screws may also be screwed on the deployment frame 115. In some embodiments, the assembling method and sizes of the structures may depend upon the weight of the entire artificial reefs to be deployed and on the subsea/ocean engineering strategy.

FIG. 5D illustrates an example of the artificial reef deployment, according to certain embodiments. In particular, FIG. 5D illustrates an example of the artificial reef deployment on the sea (surface) using the deployment frame 115 and crane 201 on a vessel 202. As illustrated in FIG. 5D, deployment of the artificial reefs 150 may be accomplished using the frame 115 and cable 145 of the crane 201. The vessel 202 may be used to transport the artificial reefs 150 to the selected marine spot for the deployment. In some embodiments, the vessel 202 with the crane 201 may be selected according to the weight of the desired deployment layout.

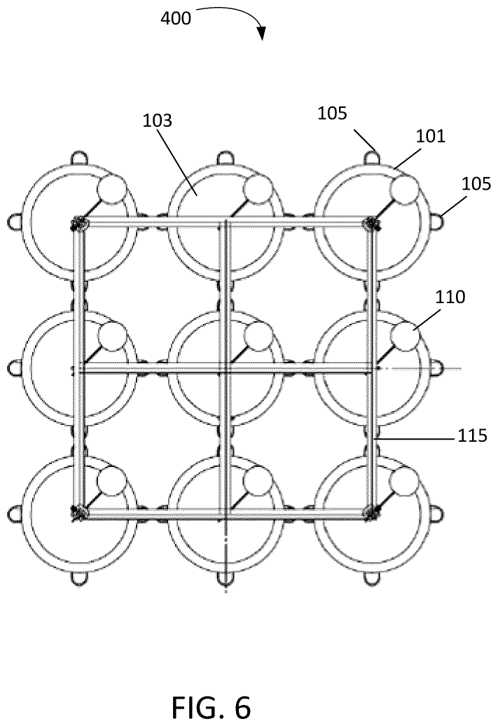

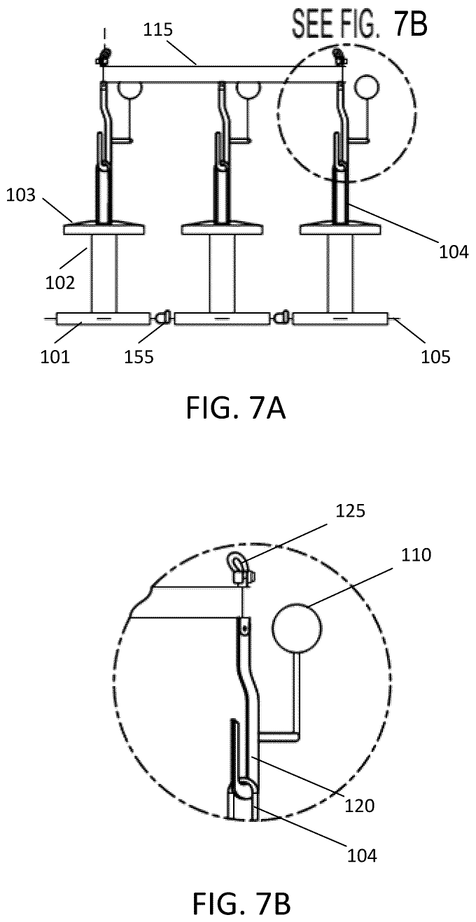

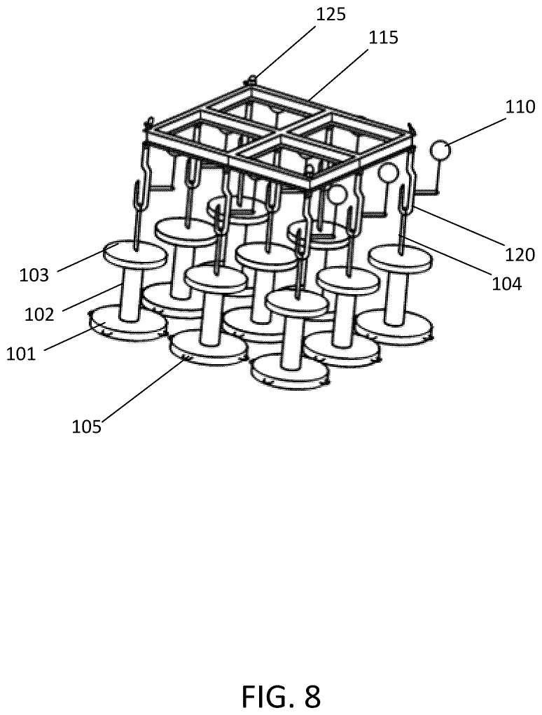

FIG. 6 illustrates example reef frame structure 400, according to certain embodiments, and FIG. 7A illustrates an example frame and reef structure, according to certain embodiments. FIG. 7B illustrates an enhanced view of a portion of the reef frame structure of FIG. 7A, according to certain example embodiments. FIG. 8 illustrates a perspective view of the reef frame structure, according to certain embodiments. In particular, FIG. 6 illustrates a top view of the reef frame structure 400. As illustrated in FIGS. 1 and 6, the reef frame structure 400 includes the frame 115 that simultaneously attaches to multiple articles via link 104 (e.g., hook) on each top 103 of each article. Each article may be connected to one or more other articles via the anchor points 105 of the base 101 and a chain, rope, and/or a link of a chain 107. In some embodiments, the frame 115 may be made of steel beams and steel handles for creating a frame that is self-detachable under the physical principle of Archimedes. As illustrated in FIGS. 6 and 8, the frame 115 includes buoys 110 attached to the frame 115 at multiple connection points of the frame 115. In certain embodiments, the buoys 110 may enable the frame to be self-detachable using the Archimedes principles. The frame 115 is also connected to the top 103 of each article so that each article can be simultaneously transported to the seabed.

As illustrated in FIG. 7A, the base 101 of each article may be connected to each other via links 155. The frame 115 may also include additional links 125 (similar to upper links 135) that may be attachable to a crane or device which allows for the entire reef frame structure 400 to be transported, shifted, or deployed. In some embodiments, the frame 115 may include hooks 120 for centralizing the deployment and the detachment of the frame 115 from the assemblage of articles.

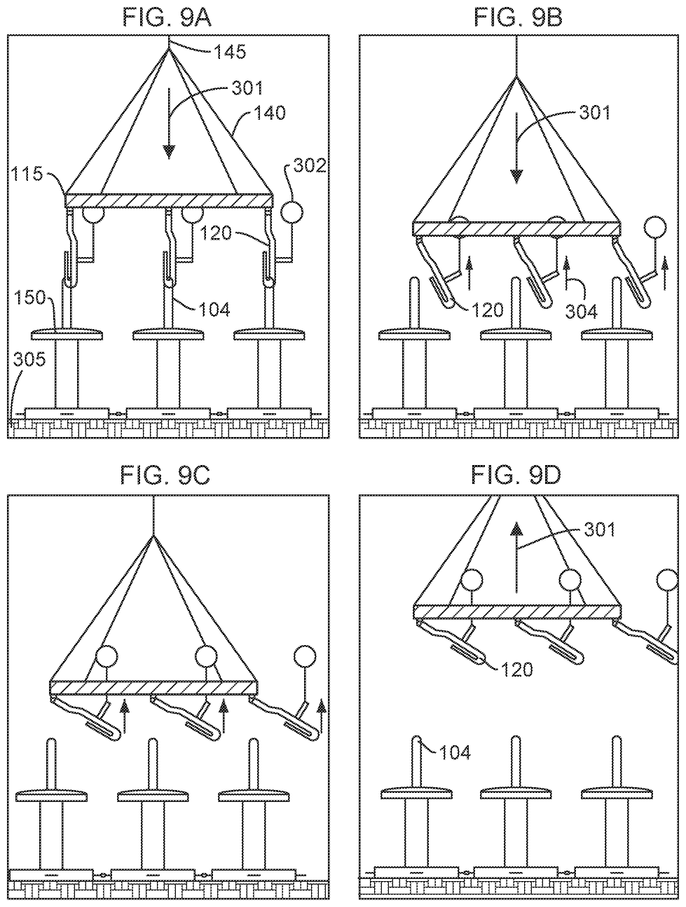

FIGS. 9A-9D illustrate an example of a sequence of the artificial reef's deployment on the sea bottom, according to certain example embodiments. As illustrated in FIGS. 9A-9D, the artificial reefs 150 reaches and sits at the sea bottom 304 (FIG. 9A). Once the artificial reefs 150 reach the sea bottom 305, the deployment frame 115 continues to move downward toward the sea bottom 305 and closer to the artificial reefs 150 (FIG. 9B). As the deployment frame 115 moves downward toward the sea bottom 305, the buoys 302 begins to lift/rise toward the sea surface and unhook the hooks 120 from the artificial reefs 150 in the direction 304 (FIGS. 9B-9D). The buoys 302 lift the easy-release connectors 120 leaving artificial reefs 150 in the sea bottom. The deployment frame 115 with the buoys 302 and the easy-release connectors 120 ascend while the artificial reefs 150 remain on the sea bottom. The arrow 301 in FIGS. 9A, 9B, and 9D illustrates the descending and ascending displacement of the entire structure during the deployment of the artificial reefs 150 using the deployment frame 115. The lifting buoys 302 lift the easy-release connectors 120 using the Archimedes principles. In some embodiments, the easy-release connector 120 may be upper attached to the deployment frame 115, and lower attached to the artificial reefs 150 and with the lifting branch attached to the lifting buoy 302. In some embodiments, the upper attachment may be articulated to allow the movement of the easy-release connector 120. As illustrated in FIG. 9B, the arrows 304 illustrate the ascending displacement of the lifting buoys 302 after the installation of the artificial reefs 150 in the sea bottom 305.

In some embodiments, the frame 115 may be made of steel (galvanized steel, or other steel composition according to the calculation of the lifted weight). The cables/ropes 140 may be steel wire cables/ropes with strong fastened eye loops that can be galvanized stainless or different materials and sizes according to the subsea/ocean engineering strategy. The upper and lower links 135, 130 may be made using lifting eye bolts, and may be galvanized stainless or different materials and sizes according to the subsea/ocean engineering strategy. In some embodiments, the connection between the upper and lower links 135, 130 with the cables 140 and the easy-release connector 120 may be made using steel rigging shackles. They may also be galvanized stainless or different materials and sizes according to the subsea/ocean engineering strategy. In some embodiments, the easy-release connector 120 may be made of steel or different metals according to the subsea/ocean engineering strategy. The size, material, and measurements of the easy-release connector 120 may be calculated based on the required strength, and may be based on the weight of each artificial reef 150 that is aimed to be installed on the seabed. According to some embodiments, the lifting buoys 302 may be made of various foams (e.g., foams that do not compress under water pressure). The lifting buoys 302 may hold the buoyancy characteristics even under several meters underwater, and the buoyancy may be determined based on the weight of the easy-release connector 120.

In certain embodiments, the lifting loop 104 of the artificial reefs 150 may be rigid and elongated according to selected measurements of the easy-release connector 120, and the lifting loop 104 may be made of steel or other metal according to the weight of the aimed artificial reefs 150 to be installed on the seabed.

According to some embodiments, the connection between the upper and lower links 135, 130 with the eye loops of the steel wire cables 140 and with the easy-release connector 120 may be made using steel rigging shackles. The assembling method and sizes of the structures may depend on the weight of the entire artificial reef 150 to be deployed and on the subsea/ocean engineering strategy. In some embodiments, the connection between the lifting branch of the easy-release connector 120 and the lifting buoy 302 may be made using steel rigging shackles and steel wire cables with eye loops on the extremities. The assembling method and sizes of the structures may depend on the weight of the easy-release connector 120 and the buoyancy of the lifting buoy 302 (to be defined by the subsea/ocean engineering). In other embodiments, the lifting-loop 104 of the artificial reefs 150 and the easy-release connector 120 may not be fixed/connected, and instead may be fitted together. The weight of the artificial reefs 150 and the shape of the easy-release connector 120 may keep the artificial reefs 150 and the easy-release connector 120 linked during the deployment process.

As illustrated in FIGS. 9A-9D, the frame 115 and artificial reefs 150 may be deployed in the ocean by arranging the artificial reefs 150 on the vessel 202 (or on a stable platform) with the desired display (according to the deployment frame 115 design). The deployment frame 115 may be assembled with the steel wire cables 140, the easy-release connector 120, and the lifting buoys 302. The steel wire cables 140 may also be connected to the link of the selected crane 201, and the crane 201 may lift the entire structure above the artificial reefs 150 and the easy-release connectors 120 may be fitted on each artificial reef 150. The deployment may be performed in a selected marine site, and after touching the sea bottom, the easy-release connector 120 may be lifted by the lifting buoys 302, and the crane 201 may ascend the deployment frame 115 for another deployment.

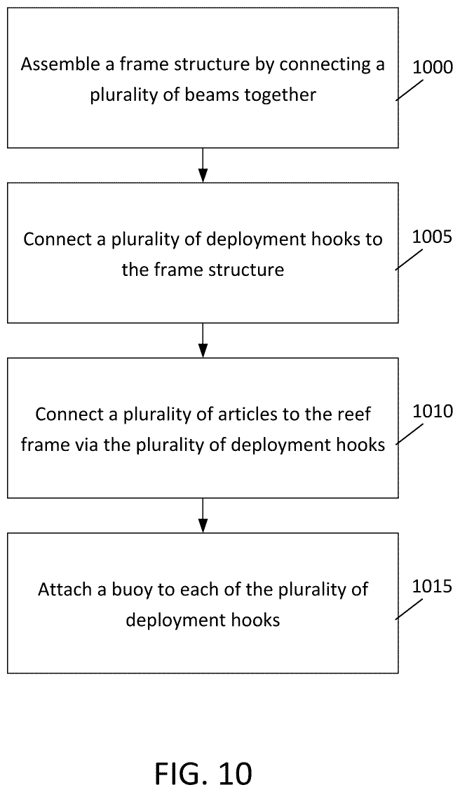

FIG. 10 illustrates an example flow diagram of a method of assembling a reef frame, according to certain embodiments. According to certain embodiments, the method of FIG. 10 may include, at 1000, assembling a frame structure by connecting a plurality of beams together. The method may also include, at 1005, connecting a plurality of deployment hooks to the frame structure. The method may further include, at 1010, connecting a plurality of articles to the reef frame via the plurality of deployment hooks. In addition, the method may include, at 1015, attaching a buoy to each of the plurality of deployment hooks. According to certain embodiments, each of the plurality of deployment hooks may be configured to attach to a respective link of each of the plurality of articles.

In some embodiments, the plurality of beams of the frame structure may be made of steel. In other embodiments, the frame structure may define a square layout, or a circular layout. In further embodiments, the frame structure may include at least one attachment link configured to attach to a crane, a lift, or a hoist.

Certain example embodiments described herein provide several technical improvements, enhancements, and/or advantages. In some example embodiments, it may be possible to group artificial reefs and deploy them together without the assistance of divers. According to certain embodiments, it may also be possible to increase habitat heterogeneity of artificial reef structures. According to further embodiments, it may be possible to improve subsea construction technology for the creation of large artificial reef systems with high habitat heterogeneity, assembling several articles with high proximity in a single spot. Additionally, it may be possible to simulate the habitat heterogeneity created in natural coral reef systems allowing for the creation of biomimetic patterns of natural habitat heterogeneity of coral reefs.

In other embodiments, it may be possible to create artificial reef layouts in the sea bottom (subsea construction). For most artificial reefs, the deployment stage in subsea construction requires the use of DP1 or DP2 vessels supported by the high cost use of remotely operated underwater vehicles (ROVs) in the vessels to create specific layouts of artificial reefs (e.g., the creation of shapes by grouping the artificial reefs underwater, shapes such as stars, squares, circles, etc.). Current methods also rely on external/remote actions/commands to release the subsea asset from the crane. However, the use of the deployment frame of certain embodiments may provide a low-cost method to assemble artificial reefs in specific shapes, and can reduce the cost by up to 80%.

For example, when observing the subsea construction using artificial reefs, the layout in the sea bottom of this subsea construction has no pattern, with a non-standardized distance between the artificial reef units because the deployment method is randomly performed. As such, it is not possible to guarantee a standardized distribution of the reef in the sea bottom as the water current and drifting of the vessel constantly changes the exact location on the sea bottom. Thus, certain embodiments herein may allow subsea engineers to improve the state of the art subsea construction by creating specific layouts of artificial reefs. Use of the deployment frame may substantially reduce costs and improve the efficiency to enhance the implementation of marine ecosystem restoration actions. Moreover, use of the deployment frame may allow for the installation of artificial reefs in large marine areas, and may also be used with different types of artificial reefs, including artworks and coral farming assets.

One having ordinary skill in the art will readily understand that the invention as discussed above may be practiced with steps in a different order, and/or with hardware elements in configurations which are different than those which are disclosed. Therefore, although the invention has been described based upon these example embodiments, it would be apparent to those of skill in the art that certain modifications, variations, and alternative constructions would be apparent, while remaining within the spirit and scope of example embodiments.

We claim:

1. A reef frame, comprising:
a frame structure comprising a plurality of interconnected beams;
a plurality of deployment hooks connected to the frame structure, and configured to connect to a plurality of articles; and
a plurality of buoys attached to each of the plurality of deployment hooks,
wherein each of the plurality of deployment hooks is configured to attach to a respective link of each of the plurality of articles.

2. The reef frame according to claim 1, wherein the plurality of interconnected beams of the frame structure are made of steel.

3. The reef frame according to claim 1, wherein the frame structure defines a square layout, or a circular layout.

4. The reef frame according to claim 1, wherein the frame structure comprises at least one attachment link configured to attach to a crane, a lift, or a hoist.

5. A method of assembling a reef frame, comprising:
assembling a frame structure by connecting a plurality of beams together;
connecting a plurality of deployment hooks to the frame structure;
connecting a plurality of articles to the reef frame via the plurality of deployment hooks; and
attaching a buoy to each of the plurality of deployment hooks,
wherein each of the plurality of deployment hooks is configured to attach to a respective link of each of the plurality of articles.

6. The method of assembling the reef frame according to claim 5, wherein the plurality of beams of the frame structure are made of steel.

7. The method of assembling the reef frame according to claim 5, wherein the frame structure defines a square layout or a circular layout.

8. The method of assembling the reef frame according to claim 5, wherein the frame structure comprises at least one attachment link configured to attach to a crane, a lift, or a hoist.
